(19) United States
(12) Patent Application Publication
(10) Pub. No.: US 2013/0041819 A1
(43) Pub. Date: Feb. 14, 2013

(54) SYSTEMS, DEVICES AND METHODS FOR MANAGING CASH FLOW

(71) Applicant: Joseph Khasho, La Grange, IL (US)

(72) Inventor: Joseph Khasho, La Grange, IL (US)

(21) Appl. No.: 13/209,355

(22) Filed: Aug. 12, 2011

(51) Int. Cl. G06Q 40/02; G06Q 40/00

(52) U.S. Cl. 705/42; 705/35; 705/39

(57) ABSTRACT

Systems, methods, and devices for managing cash flow and spending are disclosed. Such systems, methods, and devices may include generating a preliminary budget based on user input of planned or historical spending of the user. These user inputs are interfaced into a computer server, the budget having one or more budget items. Further, individual preliminary budget items are aggregated and consolidated into a small number of allocation allotments based on inherent timing and mode of payment for each of the expenses. Further such systems, methods and devices may cause to generate one or more financial accounts and a cash flow mechanism to facilitate the flow of funds coupling available funds with the planned allocation allotments. Feedback from user and/or financial institutions provide critical information to track the balance of allocation allotments in real time to chronological targets helping users better and more consistently manage spending behaviors over the budget cycle.

### SUMMARY

Many people struggle with personal finances as a result of poor spending habits or patterns that are often facilitated by the easy availability of borrowed cash (primarily through home loans and credit cards) to provide for goods and services otherwise not available except through personal savings. With tightening credit requirements the means of recent consumption has been extinguished and millions of Americans are looking for new tools and technologies to enable them to better manage personal finances.

Current budgeting systems may not be helpful for many people. Significant inefficiencies in traditional budgeting software/systems render them a better tool for spotting the cause of financial problems than for enabling individuals to overcome spending habits that lead to such problems. This is because traditional budgeting software/systems are essentially category-based systems that typically use financial data after expenditures have been made requiring much unnecessary effort to categorize, track and manage those spending categories. Such systems help report on historical spending but lack a forward looking mechanism to help people plan or make spending decisions as they actually spend money (day by day, week by week, month by month).

The continual effort needed to update amounts for these multiple categories anytime a sizable change occurs in any one of them is time consuming and may be unnecessary to achieve the goal of better spending management. For example, a significant increase in gas prices may necessitate the user (in a traditional budgeting system) to update the increase in the “Gas” category of the budget and possibly reduce other category item(s) to help offset that increase (for example, dining and/or groceries). Such tasks are largely ineffectual in helping to curb spending patterns as people are spending their money.

A person of ordinary skill in the art may recognize that the people who best save are often not monitoring actual spending at the category level. Rather, the focus of savers is often on bank account balances in order to preserve or increase cash reserve levels. Such savers then demonstrate an almost natural ability to modify spending behavior based on feedback they receive from dollar levels in their accounts to enable such reserve preservation so that if, for example, gas prices did rise significantly these savers naturally reduce other budget areas in response to balances within their account. This process is a fairly natural response to dollar levels within an account and generally does not require specific knowledge of the categories for which all spending has occurred. In effect, such people are prioritizing savings and accumulation of funds over their personal spending wants/needs in a natural way by gaining feedback to do this from the amount of money they have in their bank/financial accounts.

Conversely, for financially struggling individuals such behaviors to control spending and prioritize savings are not present or understood formally and, often facilitated by credit cards. Such spenders engage in dangerous spending patterns whereby current wants/needs take priority over the actual availability of resources to fund such wants/needs. Even those who avoid credit card debt can become very frustrated with their personal finances because their natural tendency is to spend all available income allowing for almost no cash reserve accumulation for emergencies or large-ticket expenses not to mention regular recurring non-monthly expenses such as vacation expenses (as differentiated from monthly expenses). It is also useful to note a distinction between passive budget items (generally those obligations that are billed or otherwise due and usually paid by check or via a primary checking account) and user-controlled budgeting items (generally those obligations that result from user initiated actions and paid usually with credit cards and, to a lesser extent, with cash). Because user-controlled budget items are, by far, the more volatile areas, they present the greatest risk to overspending and, thus, are at the source of most financial problems. With this understanding of behavioral tendencies, an aggregation of typical budget items into broader classifications based on the timing (e.g. monthly, non-monthly, etc) and means of spending (e.g. check, cash, card, etc.) may necessarily be a critical part of any solution.

Therefore, the spending management solution outlined herein for such spenders likely requires a new predictive current/forward looking cash-flow based budgeting system which, although based on traditional category based figures, is transformed in its final format and stripped of ineffective category-based complexities by creating aggregate allocations to correspond to the inherit timing and means by which expenses are incurred. This leverages the natural tendencies of human behavior in the management of their money. The goal is to combine technology with observations of behavioral finance (psychology) in order to simplify the process of cash flow management by a strategically separating assets used for budgeting and regulating the flow of funds between them. Simultaneously, users are provided with critical but intuitively useful feedback necessary to help them plan and make better spending decisions in real time in those areas most prone to overspending while providing measures that make it virtually impossible to overspend. The end result may be driven by integrated systems to assess, aggregate, fund and monitor balances around both the timing and means of spending thus simplifying the process of cash flow management which will help individuals control spending and increase savings.

The present disclosure combines technology with the above mentioned observational premise. Further, embodiments of the present disclosure enable a current/forward looking budgeting system to help people plan and make better spending decisions in real time while attempting to eliminate the risk of overspending. Additional embodiments combine effects of systematic money movement among multiple financial accounts (or user-controlled credit cards) to control the inflow and outflow of funds from a primary flow-through account in a manner that leverages the natural tendency to spend all available resources for immediate needs/wants without actually depleting all existing inflows and cash reserves in the process.

Other embodiments may include spending means allocations required for the primary feedback mechanism to be of optimal usefulness and may also identify and isolate problem areas and allow technology (e.g. smart-phone, tablet computers and associated spending management software programs, etc.) to help target, track and learn users spending behavior in an attempt to help users to develop managed and controlled spending patterns that are in-line with their overall spending goals (both short and long-term). Because accounts are isolated and technology is used to focus on areas prone to spending problems, the risk to overspending is significantly reduced and the task of budget management is greatly simplified. Further embodiments may include user feedback as well as a real-time monitoring of actual spending that is compared to target aggregated allocations (not individual categories) and the use of a color-coded alert system to provide easily recognizable but necessary feedback at any given point in time to show where users are relative to aggregated targets. If users are over budget, additional critical information (such as the number of days necessary without spending to return to target levels) is provided to allow users to make better spending decisions for that day, week, etc. Such embodiments may include a forecasting module to help people better plan their spending for any given day or week (etc.). For example, the forecasting module can answer the user question: If he were to spend $250 on groceries on Monday as planned and he avoids dining out the remainder of the week, will he have enough money in his budget to go out to dinner with friends and join them in attending the summer festival on Saturday. (Note: the computer system can provide the projected balance of an allocation allotment indicating where the users budget will likely be on Saturday and where it should be under normal circumstances as well as the projected surplus available). An embodiment may make clear that the focus is on determining the balance at a particular point in time in the budget cycle and thus, it is the timing and quantity of funds being spent that are of relevance not necessarily the category for which it is being spent. Computer algorithms implemented by software applications and software engines may continue to monitor and manage data to and from the end-user and/or financial institution to help keep the flow of funds between spending and savings requirements in balance on an ongoing basis.

Embodiments of the present disclosure may also provide a savings side effect. That is, over time, the overall control of outflows generally forces any increase in inflows to be accumulated and saved. This is a significant benefit that under normal circumstances is not realized. This is because individuals typically deposit all income in a single checking account where any increases in income are spent because of the natural tendency of “spending all income” and additional funds are unknowingly getting absorbed into lifestyle making it even more difficult to make use of such pay increases to help provide for increased savings or cash reserves as would likely be preferred. To make matters worse, lifestyle is now increasing over time making the savings necessary to accomplish other goals, such as funding retirement, even more difficult. Therefore, this savings accumulation can provide for both a funding of long-term financial goals (like retirement) and/or anticipated increases in expenses while forcing an aggressive savings of excess capital in the process. Moreover, anticipated liability amortization schedules may force reductions in outflows to the user as debt is paid off thereby adding significantly to savings accumulation rates over time avoiding freed up cash flows to inadvertently be absorbed into lifestyle expenses as is usually the case when such a mechanism is not present.

In addition, embodiments of the present disclosure do not only include a web/mobile software program but also a fully integrated cash flow system with multiple facets and strategic layers to manage budget planning, data consolidation, financial account separation, fund flows, user interface and in further embodiments integrating financial institution account data to provide increased functionality to end users.

Embodiments of the present disclosure include a method for managing cash flow. The method may includes several steps including generating a preliminary budget based on user input of a spending history of the user, the user input provided by a user interface into a computer server, the budget having one or more budget items. Further steps may be determining one or more allocation allotments for each budget item by consolidating the preliminary budget based on timing of one or more expenses and the mode of payment for each of the expenses as well as causing to generate one or more financial accounts and a cash flow mechanism to couple available funds with a planned timing and mode of payment for those expenses.

In addition, the user input of a spending history of the user is based on fixed expenses and a series of questions to identify planned spending for discretionary spending or may be based on a linear history and monthly income.

Additional steps of the exemplary method may be receiving input of a cost for each spending item associated with the user and aggregating the cost of each spending item to a corresponding allocation allotment. Other steps may be comparing aggregated cost of each spending item with the budget allocation allotments and providing user feedback for each spending item in a chronological relationship between current aggregated costs and allocation allotments in real-time. Also, the exemplary method may include providing user feedback alerting the user whether any spending items causing the user to be over budget as well as describing the amount of time necessary to receiver from any spending item that has caused the user to go over budget.

Other embodiments of the present disclosure may include a system for managing cash flow that includes a communication network, a computer server coupled to the communication network such that the computer server having a budget engine, a cash flow engine, a spending tracking software application, and a regulation engine. Further, the system may include a database coupled to the computer server as well as one or more client computing devices, each client computing device having client spending tracking software application and a client regulation engine. In addition, the system may include a user interface coupled to the computer server, the user interface providing spending history of a user.

Further, the computer server may store the spending history of the user in the database, the budget engine accesses the spending history of the user and determines a preliminary budget for the user, the budget having one or more budget items. Also, the cash flow engine determines one or more budget categories based on the preliminary budget and determines one or more allocation allotments for each budget item by consolidating the preliminary budget based on timing of one or more expenses and the mode of payment for each of the expenses. Further, the cash flow engine may cause the generation of one or more bank accounts based on the preliminary budget and one or more allocation allotments and may cause the generation of a cash flow mechanism between the one or more accounts to facilitate the flow of funds.

In addition, the spending tracking software application receives a cost of a spending item and stores the spending item and the cost in the database. Also, the regulation engine receives the cost of the spending item, adds the cost to determine the aggregate actual costs for that allocation allotment, compares the actual aggregated cost further allocation allotment to current allocation allotment, and provides various indicators to a user interface.

Additional embodiments of the present disclosure may include a device for managing cash flow that includes one or more processors, one or more storage devices coupled to the one or more processors, a spending tracking software application and a regulation engine implemented by the one or more processors. Further, the device may include a budget engine and a cash flow engine implemented by the one or more processors as well as a user interface coupled to the computer server, the user interface providing spending history of a user.

In addition, the computer server stores the spending history of the user in the database, the budget engine accesses the spending history of the user and determines a preliminary budget. such that the budget engine determines one or more allocation allotments for each budget item by consolidating the preliminary budget based on timing of one or more expenses and the mode of payment for each of the expenses. Also, the cash flow engine causes the generation of one or more bank accounts based on the preliminary budget and one or more allocation allotments and causes the generation of a cash flow mechanism between the one or more accounts to facilitate the flow of funds. Further, the spending tracking software application receives a cost of a spending item and stores the spending item and the cost in the database. In addition, the regulation engine receives the cost of the spending item, adds the cost to determine the aggregate actual costs for that allocation allotment, compares the actual aggregated cost further allocation allotment to current allocation allotment, and provides various indicators to a user interface.

The foregoing summary is illustrative only and is not intended to be in any way limiting. In addition to the illustrative aspects, embodiments, and features described above, further aspects, embodiments, and features will become apparent by reference to the drawings and the following detailed description

### BRIEF DESCRIPTION OF THE SEVERAL VIEWS OF THE DRAWINGS

The accompanying drawings, which are incorporated in and constitute part of this specification, illustrate embodiments of the invention and together with the description serve to explain the principles of the present disclosure. The embodiments illustrated herein are presently preferred, it being understood, however, that the invention is not limited to the precise arrangements and instrumentalities shown, wherein:

FIG. 1A is an exemplary functional block diagram of an embodiment of the present disclosure that illustrates one or more financial accounts and one or more cash flow mechanisms;

FIG. 1B is an exemplary network of devices that implement spending management software/computer systems to manage cash flow;

FIG. 2 is an exemplary block diagram of a computer server used in implementing spending management software/computer systems to manage cash flow;

FIG. 3 is an exemplary block diagram of a client computing device used in implementing spending management software/computer systems to manage cash flow;

FIG. 4 is an exemplary flowchart of an example method that manages spending and cash flow in accordance with embodiments of the present disclosure;

FIGS. 5A-5G are exemplary screenshots of an embodiment of a spending management software application as described in the present disclosure.

### DETAILED DESCRIPTION OF THE INVENTION

In the following detailed description, reference is made to the accompanying drawings, which for a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the following description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

Embodiments of the present disclosure that provide exemplary systems, devices, and methods to manage user spending and cash flow include receiving input from a user regarding an initial budget. Examples of such user input may include a highly detailed and well-structured questionnaire presented to users to determine an initial budget figure. In one embodiment, a financial advisors, on behalf of a user, may be asking the questions from a computer and entering user responses into the computer such that the responses may b analyzed later by a computer software application or the financial advisor. Further embodiments may include such a questionnaire may be provided to the user online on a website or through a mobile software application or in written form such that a third party (e.g. financial planner) may manually input data collected from the questionnaire into a database coupled to a computer server that is part of a spending management software/computer system. Similar to a traditional budget, such an initial budget may be a comprehensive plan of expenditures generating a minimum level of free cash flows (e.g. approx. 4% of gross income) to fund cash reserve build up for one-time expenses (further described in the present disclosure). Receiving input for an initial budget may include committed expenses taken by using historical data or known figures provided by the user. However, a manner in which the questionnaire may attempt to target more volatile discretionary expenditures is by assessing planned user behavior using a series of questions regarding the frequency of the activity and associated costs of the activity (based on average and/or lows and highs provided). An additional margin-of-error expense may be provided based on how dynamic the user's discretionary expense activity is and will be proportional to overall discretionary expenses.

Further embodiments may aggregate and consolidate and/or aggregate budget items/dollars to classify broader spending allocations. Such a detailed primary budget is then being consolidated into these broader groups of aggregated allocation components that correspond to the inherent timing of expenses (such as monthly and non-monthly) and the means of payment (spending means) by which those expenses are incurred (such as check(ing), card (debit/credit), cash, etc). Without limiting the scope or manner in which such aggregate allocations are determined or utilized herein, the following table is provided for general illustrative purposes only:

| Budget | Allocation | Notes |
|---|---|---|
| Monthly Budget: | Checking Allocation | |
| | Cash Allocation | |
| | Card Allocation | |
| Non-Monthly Budget: | Checking Allocation | Time and non-time |
| | | specific allocations |
| | | Cash is not usually |
| | | present but can be |
| | | accessed through the |
| | | checking allocation |
| | Card Allocation | Time and non-time |
| | | specific allocations |
| Non-Monthly Budget: | Cash Reserve Allocation | For non-budgeted |
| | | one-time expenses |

This transformation of the initial budget may be significant in helping to remove the complexities associated with the category-based data in favor of more useful simplified aggregated data components. These aggregated components correspond strategically and directly to isolate those budget items most and least prone to spending problems (means-of-spending break down of the initial budget) and providing accumulations for non-monthly and emergency reserves (the inherent timing breakdown of the initial budget). For example, aggregated allocation components specifically for the monthly budget may include aggregate dollars for a “checking allocation” (those items billed/paid through a check or online checking account as opposed to other means of payments—generally represents the largest and least volatile component of a personal budget), a “cash allocation” (those items paid with cash—generally the smallest component of a personal budget), and a “card allocation” (those items paid with a credit/debit card and representing the most volatile component of a budget most often associated with spending problems). Alternatively, there may be similar aggregated allocation components specifically for the non-monthly budget (such as a “checking allocation” and a credit “card allocation” for which each may have their own time and non-time-specific allocations to be further explained in the present disclosure) for a non-monthly budget. Further, there is cash reserve allocation for non-budgeted one-time expenses (to be further explained in the present disclosure).

In embodiments of the present disclosure, people may have a predisposition to spending all available income. Thus, a separation may be made of the primary budget into two main components; a monthly allocation and non-monthly allocation. Note that controlling the flow of funds is important considering this pre-disposition to spending all available income. Such a separation generates an accumulation of funds for non-monthly expenses and excess cash flow (usually occurring in the Flow Through/Cash Reserve Account). A monthly budget may be defined as planned expenses that are incurred at least once a month. Alternatively, a non-monthly budget may be planned expenses incurred less frequently than once a month.

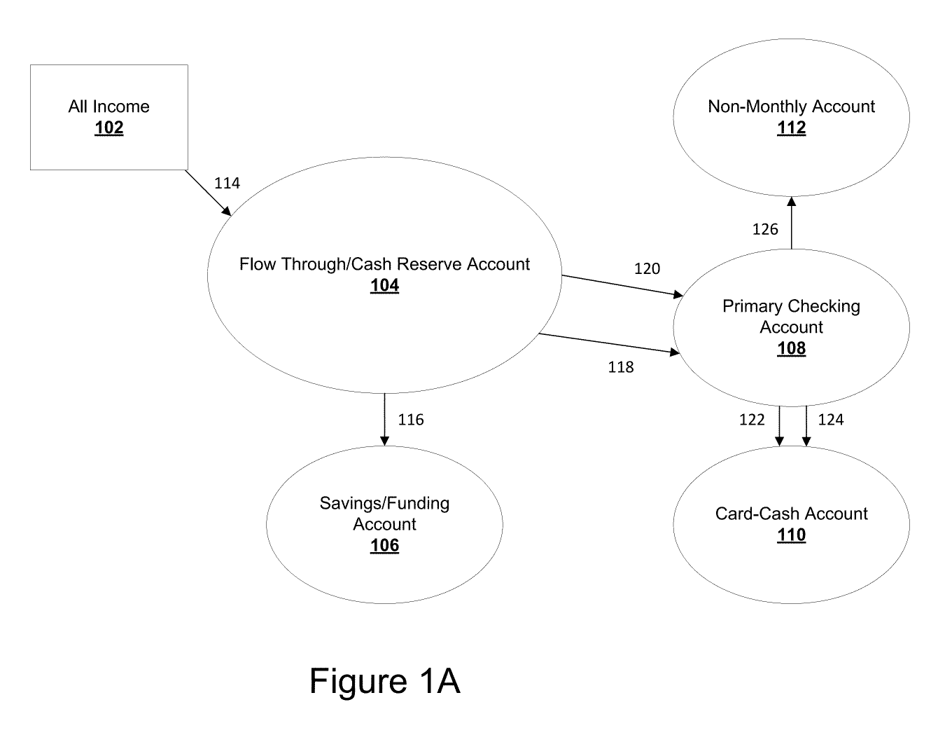

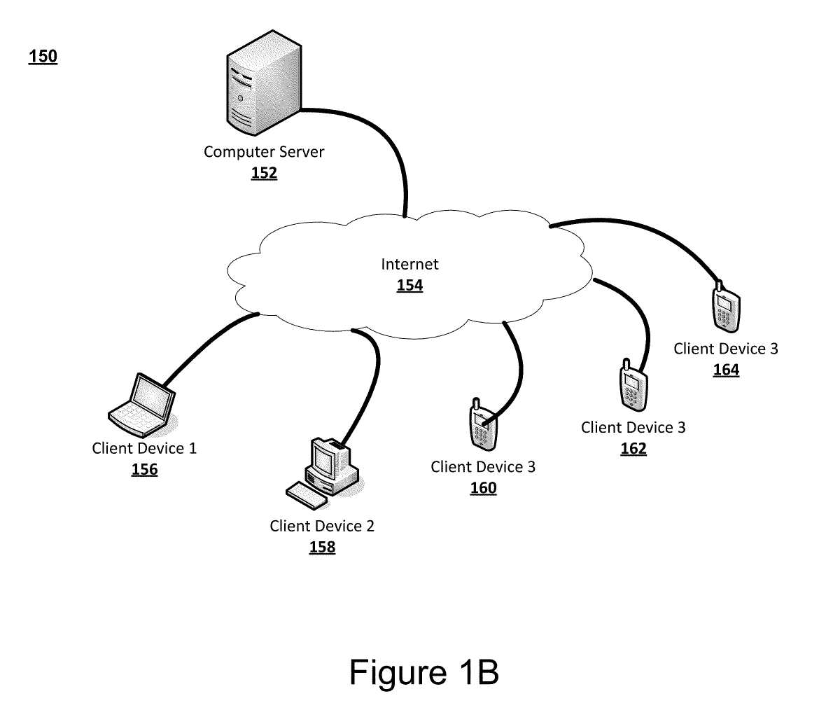

FIG. 1A is an exemplary functional block diagram of an embodiment of the present disclosure that illustrates one or more financial accounts and one or more cash flow mechanisms. In implementing a spending management system, an embodiment may include establishing a flow-through or cash reserve account 104. This cash flow-through account may be any type of financial account including, but not limited to, bank accounts such as checking and savings accounts as well as money market accounts, brokerage accounts, credit card accounts, or any other financial account known to a person of ordinary skill in the art. Further, the flow-through account is an account to control and facilitate movement of all cash in-flows (income) and all cash out-flows (expenses) including any savings expenses. A cash flow mechanism 114 may direct all monthly income 102 to the flow-through account 104: Further any other income such as wages, tax refunds, gifts, etc must be directed to and through the Flow-Through account. The cash flow mechanism may include an automated account transfer such as a direct deposit, ACH transfer, wire transfer, online payment, online transfer, or any other mechanism known to a person of ordinary skill in the art to transfer or allow to transfer funds to and from a financial account.

Based on the monthly budget, at least two checking accounts may be established that may include a primary checking account 108 and a secondary cash-card account 110. The primary checking account 108 may be a traditional checking account that systematically receives (through automated processes) the “checking-allocation” portion of the budget noted above from the Flow-Through account 118. Alternatively the primary checking account 110 may receive the total of the above mentioned “monthly” budget payout (checking, cash and “card allocation”) 120 and then systematically send (through automated processes) the cash-allocation and “card allocation” portion to the Cash-Card Account mentioned below (122 and 124) using known techniques in the art to transfer money from one financial account to another. Using either method, the primary checking account may hold only the funds needed for the “checking allocation” component of the budget with overdraft protection as an embodiment.

In addition the cash-card Account 110 receives monthly deposits for the “card allocation portion of the budget and periodic deposits (e.g. weekly, bi-weekly etc.) for the “cash-allocation” part of the budget (118-120). Further embodiments include a cash-card account that receives monthly deposits of the “card allocation” and the user is instructed to use a debit-card for spending and retains no overdraft protection on this account thereby isolating the most volatile portion of the budget. Moreover, the systems, devices, and method of managing spending discussed in the present disclosure help the user gain real-time feedback as to actual spending versus target allocations on a transaction-by-transaction basis e.g. “being 50% through the month the user is 43% through their allocation” or converting such percentage into “dollars available”/“dollars over budget”. Thus, because the “card allocation” (and to a lesser extent the cash-allocation) is most prone to overages (excess spending), this account can be isolated from all other budget areas. By separating these funds and using spending management systems, devices, and methods to regulate spending through using chronologically linear or user-specific trends (once inputted or learned by the system), the user has a clear picture of the portion of the budget they control that is most frequently used and most problem-prone but that is not tied to passive budget items (generally part of the “checking allocation”—mortgage, utilities, etc).

Further, the cash-card account 110 may receive weekly distributions of the cash-allocation portion of the budget and the user may be instructed by the system to make weekly ATM withdrawals to offset these deposits for the user's cash purchases. Because deposits equal withdrawals on a strict periodic basis (e.g. weekly), financial problems derived from uncontrolled ATM withdrawals is reduced. Any ATM withdrawals not so taken by the user will be added to funds available in the “card allocation”.

In addition, the cash-allocation component is primarily for highly discretionary parts of the budget that the user could easily do without if necessary (this may be established purposefully). In an emergency where the monthly “card allocation” is depleted prematurely for one-reason or another, the cash-allocation being received in the cash-card account 110 budget can serve as a source of back-up or emergency funds. Weekly received funds for the cash-allocation budget component can be diverted by the user (because they are highly discretionary items) to help fund more critical “card allocation” items (such as gas, groceries, etc) until the next monthly deposit is made for the “card allocation”.

Other embodiments may include the flow-through account 104 sending the monthly budget allocation (or allowing it to be sent) to the user and the user having access and control of both the primary and secondary checking accounts to manage user bills and spending according to the monthly budget. Further embodiments may include the monthly budget set-up to be sent as a single amount to a single account of the user (or into multiple accounts as described in the present disclosure) from the flow-through account 104 to the user's primary checking account 108.

As discussed in the present disclosure, the monthly expenses can be broken down into three primary means of payment that users use to spend money (check/online check, debit/credit card and cash). It is important to understand the characteristics of each of these spending or modes of payment: Checking allocation” can be items paid by check or online checking/payment. Such allocations are usually the largest component of a typical household budget but are also is the least volatile piece representing the least risk to financial problems. This is primarily because most expenses in this allocation are committed expenses and typically do not change or change in a predictable manner in a typical budgeting cycle (usually 1 year). Mortgages, car loans, cable/satellite TV, and utilities are examples of the passive budget items aggregated to the “checking allocation”. Even utility expenses (gas, electricity) which generally vary throughout the year do so in a known way that can be anticipated. Therefore, by isolating this “checking-allocation”, the largest yet least volatile portion of the initial budget is isolated from riskier areas (the card and cash allocations) and being tied to overdraft protection features, can provide added security to help prevent shortages that could otherwise impact a users credit rating negatively should a missed mortgage or other liability payment result.

In addition, the “cash allocation” (e.g. items paid for using by cash) may be smallest component of a typical household budget and, as such, represents lower risk to financial problems.

It has been observed the most volatile portion of a typical budget (and hence the most dangerous risk to personal spending) stems from the “card allocation” which is generally comprised of those user-controlled items generally paid by a card (usually credit card or debit-card tied to credit lines). The user is instructed to use a debit card without any ties to credit lines or overdraft features tied to the Cash-Card account 110 which receives the “card allocation. Since the card it is the primary means of overspending a monthly budget, embodiments of the present disclosure include specific technology is developed around this component allocation of the monthly budget to help clients monitor and better control finances in real time. This area of the system provides significant value as users interact with the system gaining valuable feedback of where the “card allocation” balances are relative to target at any given point in the month in real time. Controlling the riskiest and most volatile area of the budget, this should enable the user to plan and make better spending decisions as they spend money relative to chronologically determined target balances for a given period (e.g. spend more/less on groceries this week, plan more/less driving this weekend, eat out more/less this week) which is the primary reason the “card allocation” and, to a lesser extent, the “cash allocation” have both been isolated from other aggregate allocations of the monthly budget.

Referring to FIG. 1, a non-monthly financial account 112 may be established. The non-monthly account may be a bank account or a credit card account. A major pitfall for people may be that many household budgets fail to allocate funds for non-monthly areas especially prone to overages such as gifts, vacations or recurring one-time expenses (e.g. continual non-budgeted home improvement projects). Once again such high risk areas tend to be user-controlled card (credit/debit) transacted items. Different embodiments may deal with a non-monthly budget. For example, the user does not have a history of poor credit card use, the user may be instructed to use a credit card for non-monthly expenses compared to a debit card not tied to any lines of credit or overdraft features.

Non-monthly (“NM”) expenses may also be broken down by the two primary means of payment with which such expenses are actually incurred (e.g. checking and credit card). Note that cash is not usually relevant but accessible through checking if needed. This delineation will result in a “NM checking allocation” and a “NM card allocation”. The systems, devices and methods for managing spending aggregate and isolate all card related non-monthly expenses in a similar way that the “card allocation” part of the monthly budget was consolidated in the above description. (“NM”) expenses may be further broken down by time-specific and non-time-specific expenses. Further, one-time expenses may be treated separately since they are not part of a planned budget because they are not assumed to be regular annually recurring expenses in nature. Such a reserve is necessary to properly provide for unforeseen or major planned one-time expenses. In addition, time-specific expenses are those NM items that have a designated date by which they are anticipated to occur. For example, vacation ($3,000 annually on in August 1st) and Christmas Gifts ($2,000 annually on in November 1st). The remaining NM expenses not part of time-specific expenses are aggregated and divided by 12 (into a monthly allocation to be pooled). Additional embodiments may include the NM budget allocating funds for NM expenses:

Users identify any non-monthly expenses that are one-time expenses using a computer/software system for managing spending. Because one-time expenses are not expected to recur they may be added-back in the expense reporting feature to show such non-monthly expenses would have been without one-time expenses. Such a feature helps identify otherwise good spending patterns in the midst of a year where a major one-time expense was incurred whether unplanned (e.g. medical emergency) or planned (e.g. new windows for the house).

Funds for one-time expenses may be taken from a cash reserve allocation and aggregated separately in the spending management system. Then, based on anticipated (or actual savings rates), the period of time needed to rebuild cash reserves depleted by one-time expenses may be shown to the user to help them manage any planned one-time expenses. So as a user depletes budgeted cash reserves (through one-time expenses or overages in non-monthly expenses), the user interface of such a computer system may reflect those shortages and provide detail regarding the amount of time (based on expected/actual savings rates) it will take to recover to cash reserve targets. Another embodiment of a forecasting module, may also help provide users with the ability to predict and plan their finances and spending. For example, if a user spends $3,000 to do major landscaping work on his yard in April, will he have enough reserves to both provide for $4,000 of window replacements in October while still leaving $5,000 for emergencies?

FIG. 1B is an exemplary network of devices 150 that implement spending management software/computer systems to manage cash flow. Embodiments of a spending management software/computer system described in the present disclosure may include a software applications and engines running on both a computer server 152 and on one or more client computing devices (156-164) and interact with one another in a client-server relationship known to a person of ordinary skill in the art. Client computing devices may include mobile phones, smartphones, tablet computers, laptop computers, desktop computers or any other type of computing device.

Embodiments of the present disclosure may include a user entering user spending history using various methods. For example, the user may access a web site using a web browser through the user interface of the client computing device. The user or a third party (e.g. user's financial planner) may then manually input the user spending history. Alternatively, the user may upload financial statements from one or more financial institutions and/or financial data from a financial software program (e.g. Quicken, TurboTax, etc.). Further, a user may be asked a series of questions to indentify planned spending. Persons of ordinary skill in the art would understand that a user may use a combination of the various methods to enter a user's spending history. The user input and the spending history will be transferred to the computer server 152 across the communication network 154.

The computer server 152 may generate a preliminary budget based on the user spending history received from a client computing device (156-164). In addition, the user may provide planned or future items to the computer server 152 via client device (156-164) user interface and communication network 154 that should be included in the preliminary budget. Alternatively, the user may provide the computer server 152 via client device (156-164) user interface and communication network 154 user monthly income. If preferred, the user may generate a linear history as a preliminary budget based on the user monthly income. For example, a linear history based preliminary budget may be as follows. A user may earn $10,000 in monthly income. The preliminary budget indicates that the cash-credit financial account should receive $3,000 a month. Thus, for a 30-day month, the user is budgeted to spend up to $100 per day. Alternatively, if a preliminary budget is based on user spending history, the preliminary budget may indicate that $2,000 of the $3,000 budget of the cash-card account is usually spent in the first 10 days of the month. Hence, the budget takes into account that the user can spend up to $200 per day for the first 10 days of every month. However, the budget indicates that the user may only spend $50 per day for the last 20 days of the month.

Based on the preliminary budget, the computer server 152 determines one or more allocation allotments for each budget items based on timing of expenses as well as the characterization of the budget items (e.g. monthly, non-monthly, fixed expenses, discretionary expense, etc.) Further, the computer server 152 may interact with one or more financial institutions directly or indirectly, in an automated fashion or though manual user or third party intervention to establish one or more financial accounts, each of which may correspond to an allocation allotment and the computer server 152 may provide instructions to transfer funds to different financial accounts as part of a cash flow mechanism.

For example, user may have a monthly income of $10,000. The computer server may direct to establish a flow through account in which the monthly income is directly deposited. Further, a preliminary budget based on past spending history and planned future items of $6,000 in monthly items is determined. About $4,000 are due to fixed expenses (e.g. mortgage payment, phone, utility bills, etc.) and $2,000 are due to discretionary spending. Thus, a monthly allocation allotment for fixed expenses (e.g. dining, groceries, gas, etc.) may be a checking account and a monthly allocation allotment for discretionary expenses may be a separate checking account, both of which may be established indirectly by the computer server 152. Further, the non-monthly allocation allotment may be $2,000 such that a credit card account is established with a financial institution to render payment for such non-monthly expenses (e.g. vacation, home repairs (planned and unplanned), emergency medical expenses, etc.) Such a credit card account may also be established indirectly by the computer server 152. The $2,000 non-monthly allocation allotment per month may be held in the flow through account and made available when non-monthly expenses are incurred. In addition, the computer server 152 may establish direct or indirectly a savings or funding account to deposit $2,000 every month based on the preliminary budget.

The computer server 152 may also interact with the one or more financial institutions to implement one or more cash flow mechanisms. For example, every month, as part of the cash flow mechanism, funds are transferred from the flow through account to the checking account and then to the cash-card account. Further, as part of the cash flow mechanism, money may be transferred from the flow-through account to a savings or funding account each month. Moreover, when non-monthly expenses are incurred, the user via a client computing device (156-164) user interface may instruct the computer server to provide instructions to a one or more financial instructions to transfer funds to the non-monthly credit card account as part of the one or more cash flow mechanisms.

A user may purchase an item using a debit card such as groceries which is budgeted as part of the monthly allotment. Thus, the user would pay for groceries out of the card-cash account using the debit card associated with the card-cash account. The user would have a spending management software application running on a client computing device such as a mobile application on a smartphone. Thus, a user may enter the cost of the groceries into the spending software application. A spending tracking application that is part of the spending management application records the cost and identifier of the item (e.g. groceries) and uploads such data to a computer server. The computer server then processes the data using a server spending tracking software application and a regulation engine. The regulation engine may add the cost of the item to the aggregated cost of each spending item and compares the aggregated cost to the monthly allotment. Further, the regulation provides user feedback for each spending time when entered based on the chronological relationship between current aggregated costs and the monthly allotment in real time. This user feedback may be transmitted to and displayed on the user client computing device. Thus, the user can change spending behavior going forward based on such user feedback. For example, if the user feedback indicates that the user is over 6% over budget and that the user may be on budget if no further spending is done for the next two days, the user may plan accordingly. That is, the user may eat at home instead of dining out or use public transportation instead of using gas for his car to spend less money and to return on budget in the next few days.

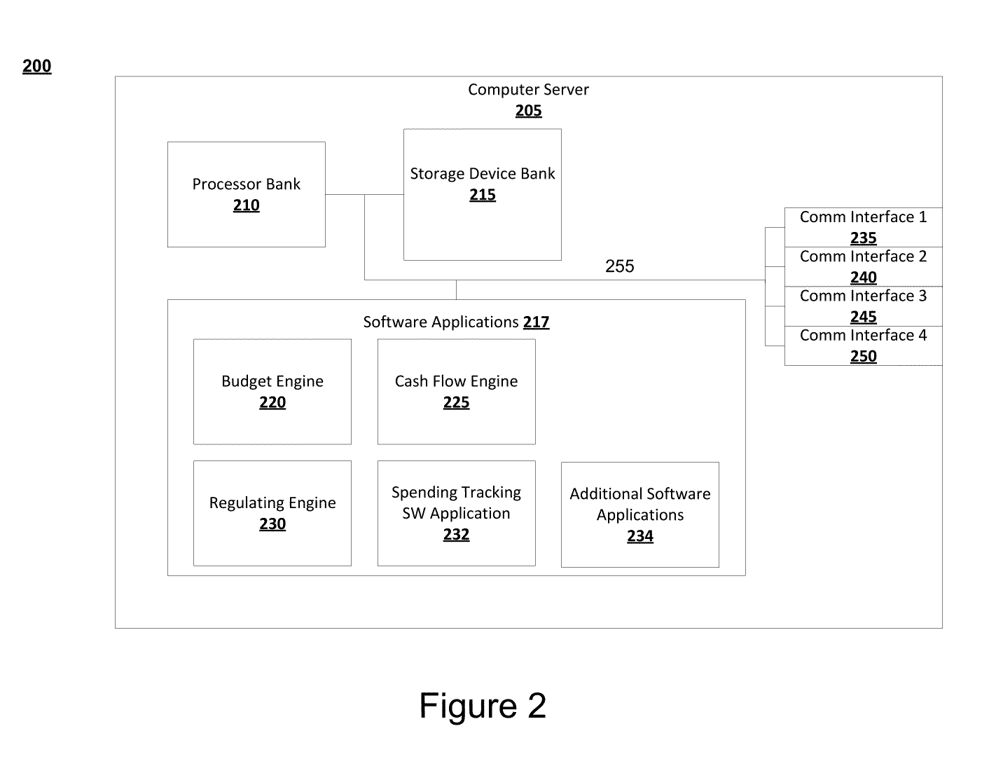

FIG. 2 is an exemplary block diagram of a computer server 205 used in implementing spending management software/computer systems to manage cash flow. Such a computer server 205 may be used in a network shown in FIG. 1A. The computer server 205 may include several different components such as a processor bank 210, storage device bank 215, one or more software applications 217, and one or more communication interfaces (235-250). The processor bank 210 may include one or more processors that may be co-located with each other or may be located in different parts of the computer server 205. The storage device bank 215 may include one or more storage devices. Types of storage devices may include memory devices, electronic memory, optical memory, and removable storage media. The one or more software applications 217 may include a budget software engine 220, a cash flow software engine 225, a regulation software engine 230, a spending tracking software application 232 and additional software applications 234 and may be implemented by the one or more processors in the processor bank 210. The control software applications may implement software functions that assist in performing certain tasks for the computer server 205 such as providing access to a communication network, executing an operating system, managing software drivers for peripheral components, and processing information. The additional software applications may include software drivers for peripheral components, user interface computer programs, debugging and troubleshooting software tools. The budget engine 220 determines a user's spending history, allocation allotments, and preliminary budget. The cash flow engine 225 causes a generation of one or more financial accounts based on the budget and the allocation allotments determined by the budget engine 220. Further, the cash flow engine 225 causes a generation of a cash flow mechanism between the one or more financial accounts to facilitate the flow of funds. The spending tracking software application receives a cost (actual costs) of the spending item via user input or through a communication network via a financial institution and stores the cost and identifier of the spending item in a database in the storage device bank 215. Note. persons of ordinary skill in the art would understand that portions of the storage bank and hence portions of the database may be located on different devices coupled to the computer server 205. The regulation engine 230 receives the cost of the spending item to determine the aggregate actual costs for that allocation allotment, compares the actual aggregated cost for that allocation allotment to the current allocation allotment, and provides various indicators to a user interface.

As mentioned in the present disclosure, the budget engine 220 determines a user's spending history, allocation allotments, and preliminary budget. Spending history may be inputted to the budget engine a number of different ways. A user may transmit data entered manually into a client computing device. Further, the user may upload electronic copies of financial statements, data from financial programs (e.g. Quicken or TurboTax) or answer a series of questions presented online (either web page or application on mobile device). Whatever manner in which spending history for fixed and discretionary expenses as well as planned future items to be purchases (e.g. home repair, new car, etc.) is received by the computer server 205, the budget engine receives and processes such data to determine a preliminary budget for the user. Further, the budget engine determines the allocation allotments for each allocation based on the preliminary budget. For example, the computer server 205 and the budget engine 220 may determine the he/she receives $10,000 in monthly income. and that by analyzing the user's spending habits, determine that the monthly allotment to be $6,000 per month. However, the fixed expenses for the monthly allotment may be $4,000 (e.g. mortgage, utility bills, etc.) and the discretionary expenses to be $2,000.

Based on the preliminary budget, the computer server 205 determines one or more allocation allotments for each budget item based on timing of expenses as well as the characterization of the budget items (e.g. monthly, non-monthly, fixed expenses, discretionary expense, etc.) Further, the computer server 205 may interact with one or more financial institutions directly or indirectly using the cash flow engine 225, in an automated fashion or though manual user or third party intervention to establish one or more financial accounts, each of which may correspond to an allocation allotment and the computer server 205 may provide instructions to transfer funds to different financial accounts as part of a cash flow mechanism.

For example, user may have a monthly income of $10,000. The cash flow engine 225 may direct to establish a flow through account in which the monthly income is directly deposited. Further, a preliminary budget based on past spending history and planned future items of $6,000 in monthly items is determined. About $4,000 are due to fixed expenses (e.g. mortgage payment, phone, utility bills, etc.) and $2,000 are due to discretionary spending. Thus, a monthly allocation allotment for fixed expenses (e.g. dining, groceries, gas, etc.) may be a checking account and a monthly allocation allotment for discretionary expenses may be a separate checking account, both of which may be established indirectly by the cash flow engine 225. Further, the non-monthly allocation allotment may be $2,000 such that a credit card account is established with a financial institution to render payment for such non-monthly expenses (e.g. vacation, home repairs (planned and unplanned), emergency medical expenses, etc.) Such a credit card account may also be established indirectly by the cash flow engine. The $2,000 non-monthly allocation allotment per month may be held in the flow through account and made available when non-monthly expenses are incurred. In addition, the cash flow engine may establish direct or indirectly a savings or funding account to deposit $2,000 every month based on the preliminary budget.

The cash flow engine 225 may also interact with the one or more financial institutions to implement one or more cash flow mechanisms. For example, every month, as part of the cash flow mechanism, funds are transferred from the flow through account to the checking account and then to the cash-card account. Further, as part of the cash flow mechanism, money may be transferred from the flow-through account to a savings or funding account each month. Moreover, when non-monthly expenses are incurred, the user via a client computing device user interface may instruct the computer server 205 and hence the cash flow engine 225 to provide instructions to a one or more financial instructions to transfer funds to the non-monthly credit card account as part of the one or more cash flow mechanisms.

The cash flow engine may establish one or more financial accounts and implement parts of the cash flow mechanism in a variety of ways. In one embodiment the cash flow engine can interact with one or more computer systems of a financial institution through an application programming interface (API) or through one or more communication protocols over a communication network. Thus, the cash flow engine 225 may provide commands or instructions to the one or more computer systems of a financial institution to establish one or more financial accounts and or implement money transfers between the one or more financial accounts.

In another embodiment, the cash flow engine 225 may provide a message to a user to establish the one or more financial accounts and the monthly or non-monthly or any type of money transfer between the financial accounts. Alternatively, such a message may be sent to a third party such as a financial planner to establish the one or more financial accounts and the monthly or non-monthly or any type of money transfer between the financial accounts. Such messages may be sent either via an email program (that could be one of the additional software applications 234) or a text message to a user's mobile device (also supported by one of the additional software applications 234). Alternatively, the cash flow engine may send a message to client spending software application running on a user's client computing device that displays the message on the client computing device display.

In another embodiment, the spending tracking software application receives a cost of the spending item via user input or through a communication network via a financial institution and stores the cost and identifier of the spending item in a database in the storage device bank 215. For example, a user may purchase an item using a debit card such as groceries which is budgeted as part of the monthly allotment. Thus, the user would pay for groceries using the debit card associated with a card-cash account. The user would have a spending management software application running on a client computing device such as a mobile application on a smartphone. Thus, a user may enter the cost of the groceries into the spending software application. A spending tracking application that is part of the spending management application records the cost and an identifier of the item (e.g. groceries) and uploads such data to the spending tracking software application 232 on the computer server 205. The spending tracking software application 232 processes the data and transmits it to regulation engine 230 for further processing.

The regulation engine 230 may add the cost of the item to the aggregated cost of each spending item and compares the aggregated cost to the monthly allotment based on the preliminary budget. Further, the regulation engine 230 provides user feedback for each spending time when entered based on the chronological relationship between current aggregated costs and the monthly allotment in real time. This user feedback transmitted to and displayed on the user client computing device. Thus, the user can change spending behavior going forward based on such user feedback. For example, if the user feedback indicates that the user is over 6% over budget and that the user may be on budget if no further spending is done for the next two days, the user may plan accordingly. That is, the user may eat at home instead of dining out or use public transportation instead of using gas for his car to spend less money and to return on budget in the next few days.

Other embodiments of the regulation engine 230 may provide commands to the cash flow engine based on whether the user is over budget in one aspect of the budget based on the allocation allotment. If so, the regulation engine 230, for example, may provide commands to the cash flow to send instructions to a financial institution that has control of the corresponding account to place a hold n the funds on that account until time has passed that the user is back on track in terms of the budgeted allotment.

Different embodiments may be used to provide the user feedback generated by the regulation engine 230. Such user feedback may be incorporated in messages may be sent either via an email program (that could be one of the additional software applications 234) or a text message to a user's mobile device (also supported by one of the additional software applications 234). Alternatively, a message may be sent to client spending software application running on a user's client computing device that displays the message on the client computing device display.

Each of the communication interfaces (235-250) shown in FIG. 2 may be software or hardware associated in communicating to other devices. The communication interfaces (235-250) may be of different types that include a user interface, USB, Ethernet, WiFi, WiMax, wireless, optical, cellular, or any other communication interface coupled to communication network. One or more of the communication interface (235-250) may be or coupled to a user interface known in the art.

An intra-device communication link 255 between the processor bank 210, storage device bank 215, software applications 217, and communication interfaces (230-245) may be one of several types that include a bus or other communication mechanism.

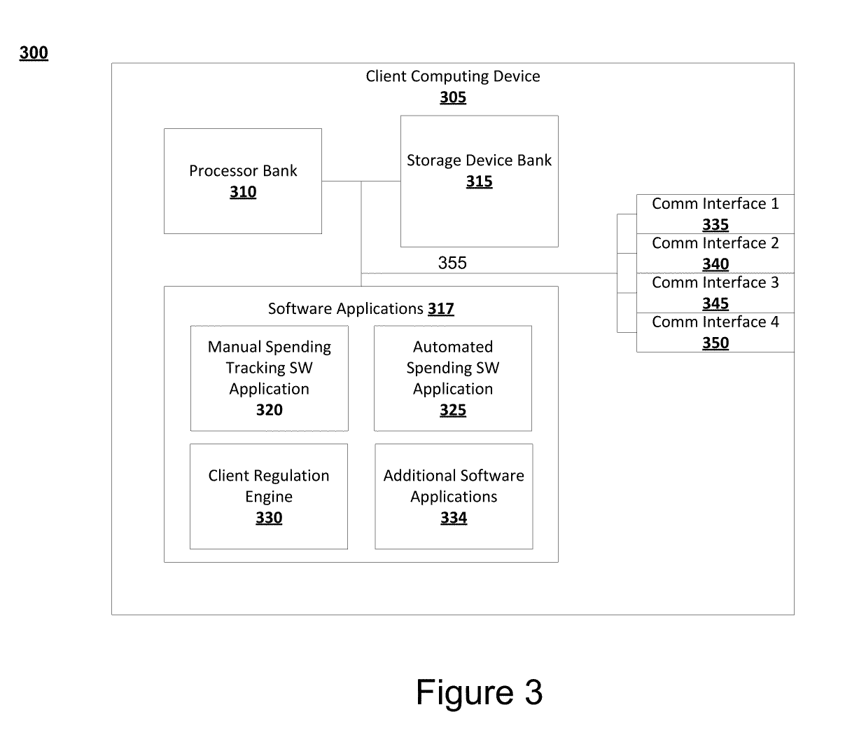

FIG. 3 is an exemplary block diagram of a client computing device 305 used in implementing spending management software/computer systems to manage cash flow. Such a client computing device 305 may be used in a network shown in FIG. 1A. The client computing device 305 may include several different components such as a processor bank 310, storage device bank 315, one or more software applications 317, and one or more communication interfaces (335-350). The processor bank 310 may include one or more processors that may be co-located with each other or may be located in different parts of the computer server 305. The storage device bank 315 may include one or more storage devices. Types of storage devices may include memory devices, electronic memory, optical memory, and removable storage media. The one or more software applications 317 may include a manual spending tracking software application 320, an automated spending tracking software application 325, a client regulation software engine 330, and additional software applications 334 and may be implemented by the one or more processors in the processor bank 310. The additional software applications 334 may implement software functions that assist in performing certain tasks for the client computing device 305 such as providing access to a communication network, executing an operating system, managing software drivers for peripheral components, and processing information. Further, the additional software applications 334 may include software drivers for peripheral components, user interface computer programs, debugging and troubleshooting software tools. The manual spending tracking software application 320 receives a cost of the spending item via user input and stores the cost and identifier of the spending item in a database in the storage device bank 315. Alternatively, the automated spending tracking software application 325 receives a cost of the spending item through a communication network via a financial institution or by synchronizing data with storage device bank 215 in order to store the cost and identifier of the spending item in a database in the storage device bank 315. The client computing device 305 may use both types of spending tracking software applications (320-325) or only one of such software applications. The client regulation engine 330 receives the cost of the spending item and determines the aggregate actual costs for that allocation allotment, compares the actual aggregated cost for that allocation allotment to the current allocation allotment, and provides various indicators to a user interface.

In an embodiment, the manual spending tracking software application 320 receives a cost of the spending item via user input and stores the cost and identifier of the spending item in a database in the storage device bank 315. For example, a user may purchase an item using a debit card such as groceries which is budgeted as part of the monthly allotment. Thus, the user would pay for groceries out of the card-cash account using the debit card associated with such card-cash account. The user would have a spending management software application running on a client computing device such as a mobile application on a smartphone. Thus, a user may enter the cost of the groceries into the spending management software application. The manual spending tracking application 320 that is part of the spending management application records the cost and an identifier of the item (e.g. groceries) and uploads such data to the spending tracking software application on a computer server. The server spending tracking software application may process the data and transmits it to a server regulation engine for further processing.

In another embodiment, the automated spending tracking software application 325 receives a cost of the spending item through a communication network via a financial institution and stores the cost and identifier of the spending item in a database in the storage device bank 315. The automated spending software application 325 may have an application programming interface or some other communication mechanism that allows financial institutions to provide a cost of a recently purchased item as well as an identifier of the item. The cost and identifier of the item may then be uploaded to a computer server for further processing by the server spending tracking information and provides the data to the regulation engine. The regulation engine on server provides user feedback based on the recently purchased item. Conversely, the financial institution may send the cost and identifier of the spending item to the computer server which then downloads such data to the automated spending tracking software application running on the client computing device 305.

The client regulation engine 330 receives user feedback from the server regulation engine and processes it to be displayed to the user or texted to a mobile phone. Further, the client regulation engine may have the same or more functionality than the server regulation engine described in the present disclosure. For example, the client computing device may not be connected to the communication network, and, thus cannot receive any feedback from a computer server. Therefore, a user may enter the cost of a recently purchased item but may not be able to upload such data to a computer server for further processing. In addition, the server regulation engine cannot provide user feedback based on the recently purchased item. However, the client regulation engine 330 would have information regarding the last calculation of the aggregated cost of the previous spending items and the comparison of the aggregated cost to the allocation allotment. Thus, the client regulation engine 330 may add the cost of the recently purchased item to the aggregated cost, compare the aggregated cost to the allocated allotment, and provide user feedback. In some embodiments, such user feedback may not be accurate as the user may have purchased previous items using a different client computing device the information of which may not be available to the client regulation engine 330.

Different embodiments may be used to provide the user feedback generated by the client regulation engine 330. Such user feedback may be incorporated in messages may be sent either via an email program (that could be one of the additional software applications 334) or a text message to a user's mobile device (also supported by one of the additional software applications 334). Alternatively, a message may be sent to client spending software application running on a user's client computing device that displays the message on the client computing device display.

Each of the communication interfaces (335-350) shown in FIG. 2 may be software or hardware associated in communicating to other devices. The communication interfaces (335-350) may be of different types that include a user interface, USB, Ethernet, WiFi, WiMax, wireless, optical, cellular, or any other communication interface coupled to communication network. One or more of the communication interface (335-250) may be or coupled to a user interface known in the art.

An intra-device communication link 355 between the processor bank 310, storage device bank 315, software applications 317, and communication interfaces (330-345) may be one of several types that include a bus or other communication mechanism.

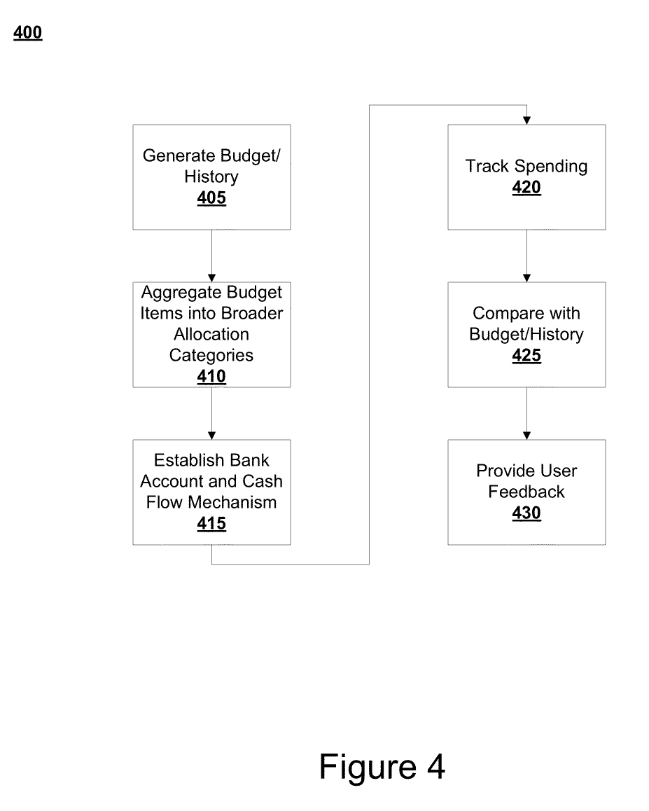

FIG. 4 is an exemplary flowchart 400 of an example method that manages spending and cash flow in accordance with embodiments of the present disclosure. A step in the example method may be generating a preliminary budget based on user input of a spending history of the user, as shown in block 405. The user input may be provided by a user interface of a client computing device and uploaded to a computer server. The preliminary budget may include one or more budget items. A further step may be determining one or more allocation allotments for each budget item by consolidating the preliminary budget based on timing of one or more expenses and the mode of payment for each of the expenses, as shown in block 410. For example, the preliminary budget may include monthly expenses that are fixed and monthly expenses that are discretionary. The combination of such fixed and discretionary expenses may be determined to be the monthly allotment. Another step in the example method may be causing to generate one or more financial accounts and a cash flow mechanism to couple available funds with a planned timing and mode of payment for those expenses, as shown in block, 415. A computer server that determined the preliminary budget may have a cash flow engine to establish one or more financial accounts as well as one or more cash flow mechanisms, both of which are described in the present disclosure. An additional step in the example method may be tracking spending using the client device which uploads spending information such as cost of purchased items and associated item identifiers to a computer server for processing, as shown in block 420. For example, a user may enter the cost and identifier of a recently purchased item using a mobile application on a user's mobile device. Further, the computer server may be receiving input of a cost for each spending item associated with the user. Another step in the example method may be determining the aggregated cost of each spending item and compare such aggregated cost to a budget of finance history, as shown in block 425. Such functionality may be performed by a regulation software engine running on the client computer device or on the computer server. Another step in the example method may providing user feedback alerting the user whether any spending items causing the user to be over budget, as shown in block 430. Another embodiment of such a step in the example method may be providing further user feedback describing the amount of time necessary to recover or to be back on track due to purchasing the spending item that has caused the user to go over budget. The user feedback may be provided by email or any message supported by the computer server.

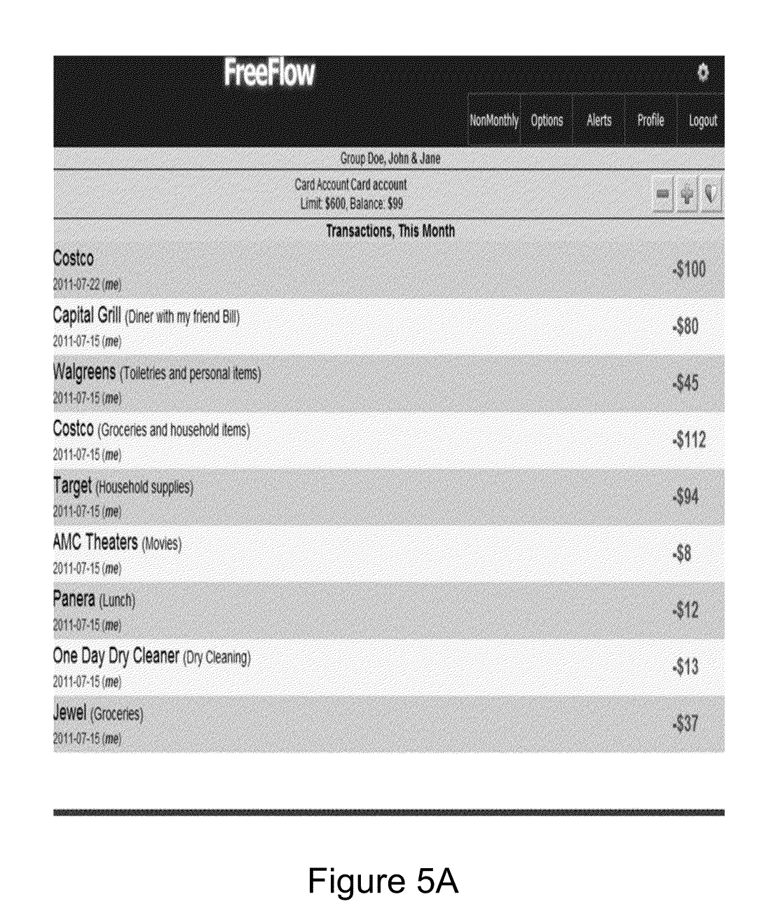

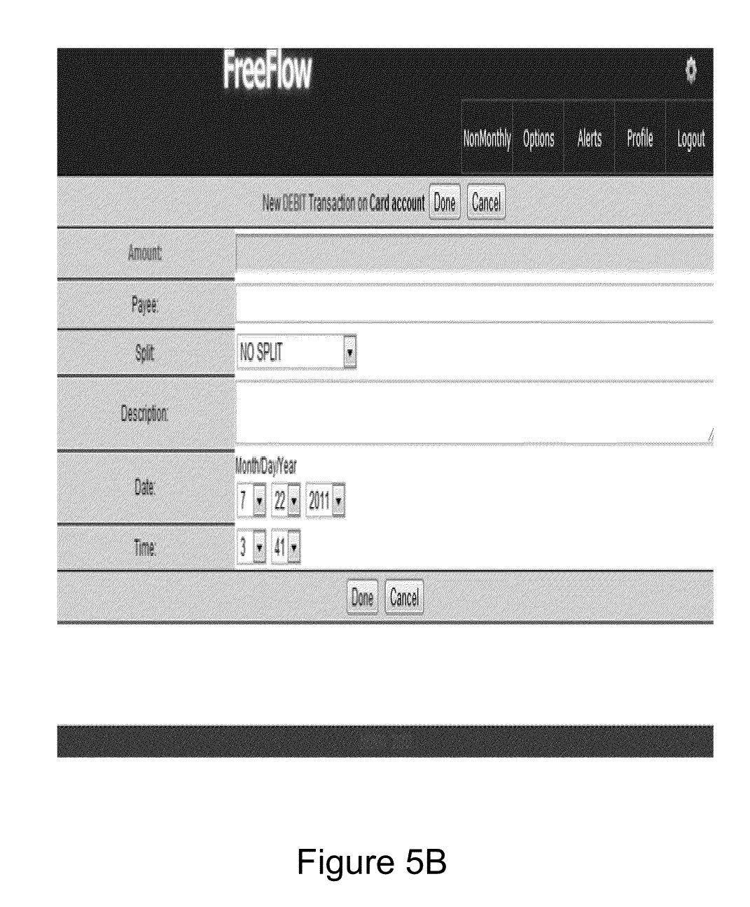

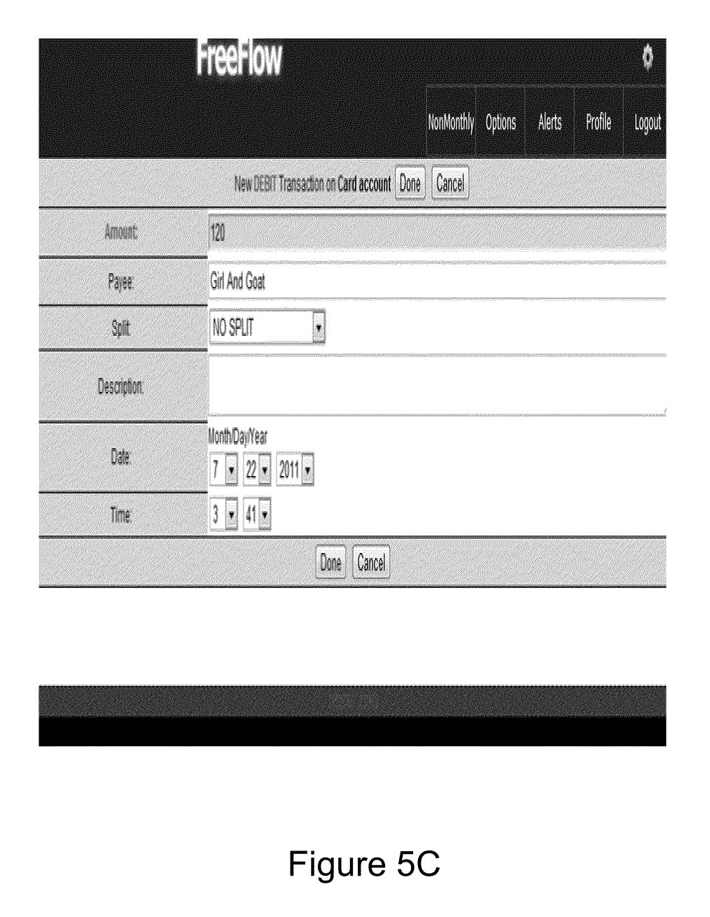

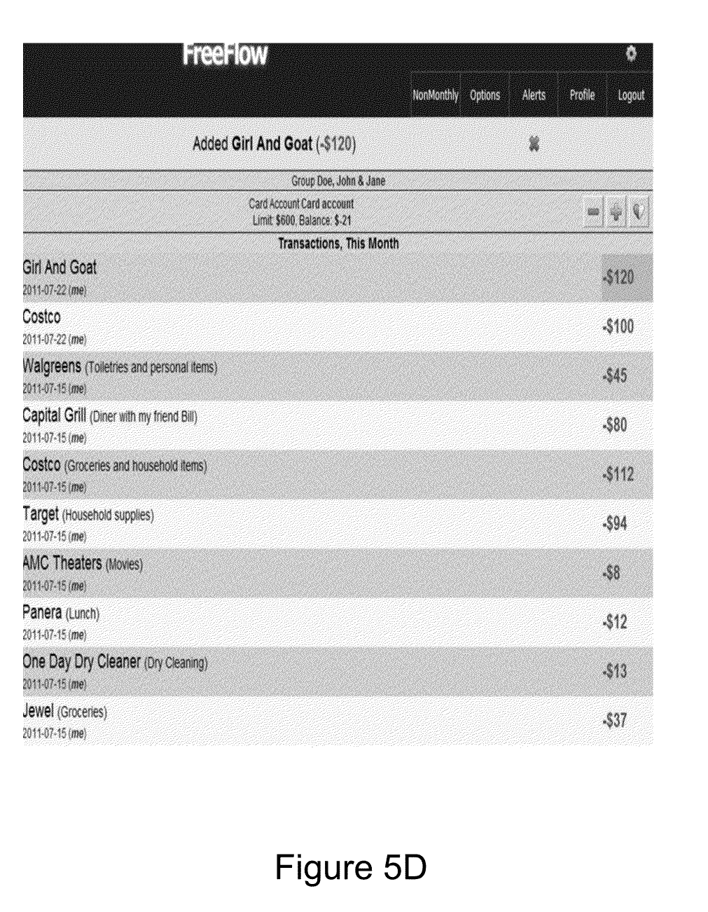

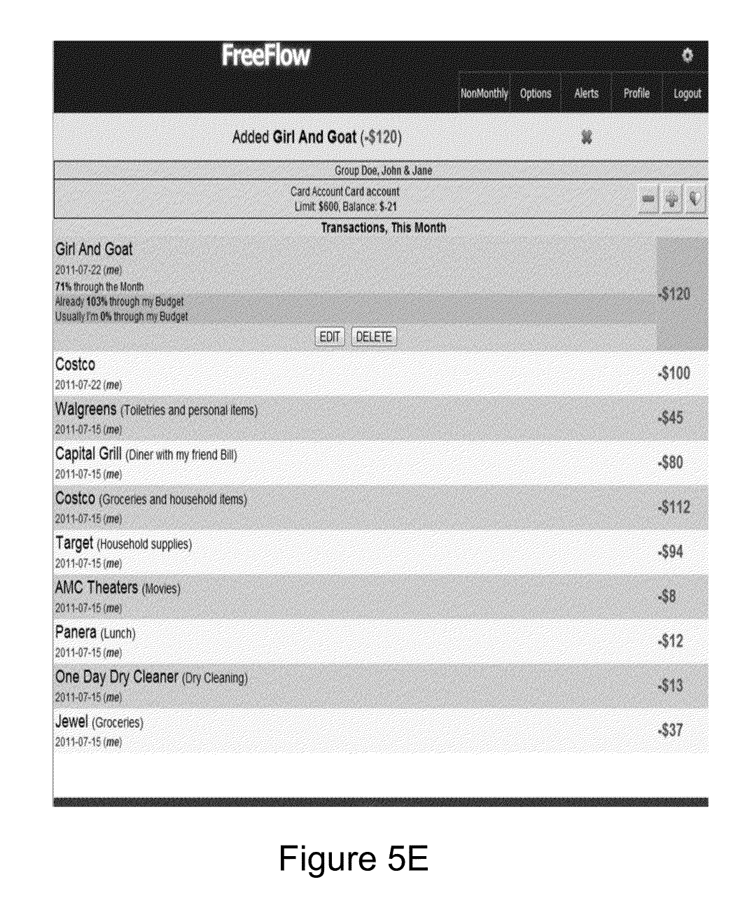

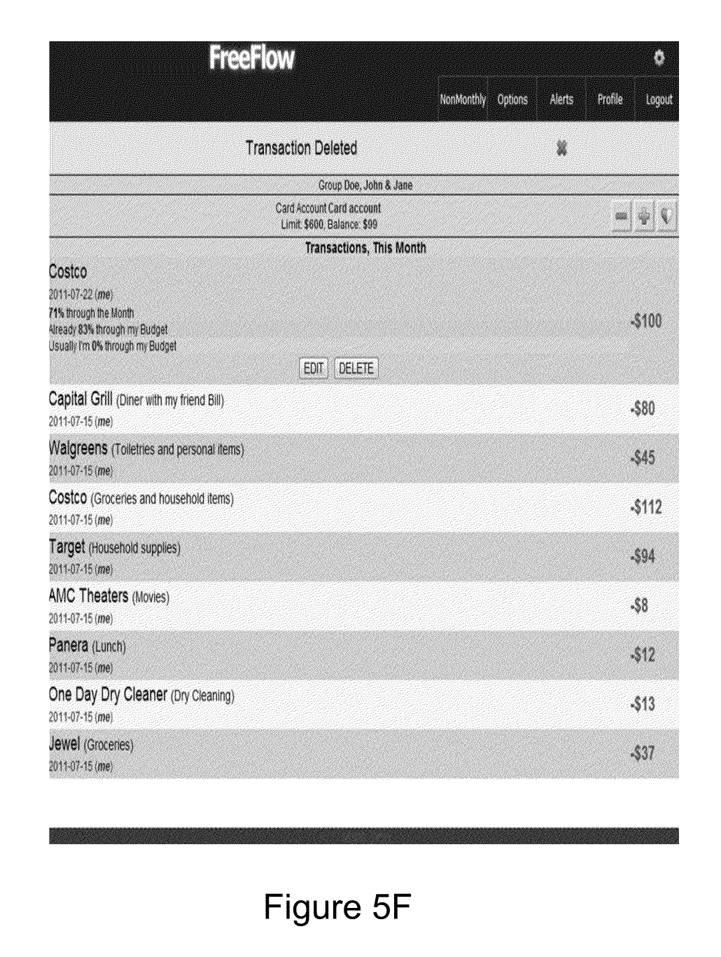

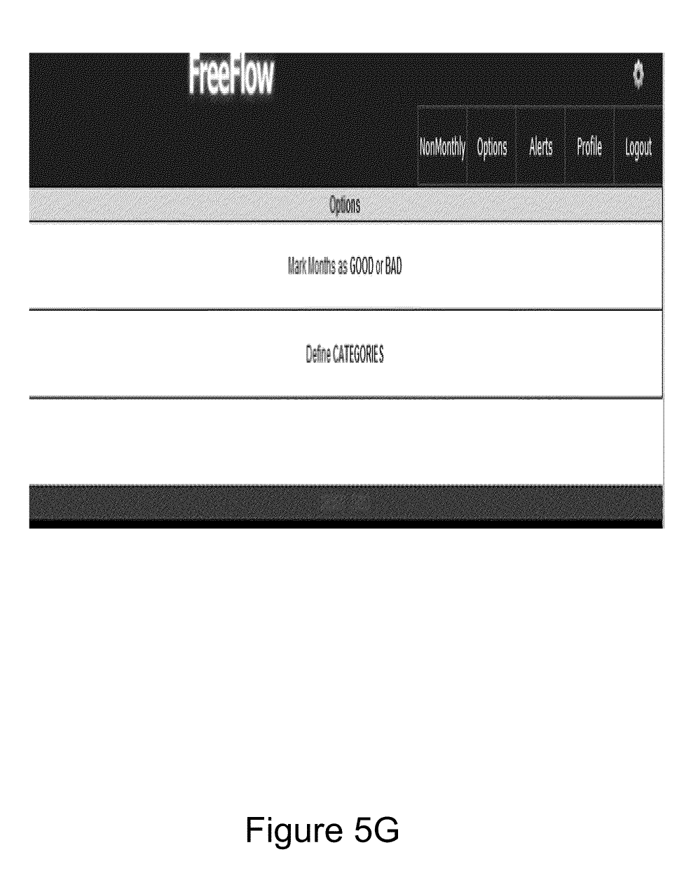

FIGS. 5A-5G are exemplary screenshots of an embodiment of a spending management software application as described in the present disclosure. Referring to FIG. 5A, the exemplary screenshot is of an exemplary spending management software application running on a client computing device such as a mobile device or a desktop computer. Such an application may have client software running on the client computing device that interact with server software running on a computer server across the network as described in the present disclosure. The screenshot in FIG. 5A shows a list of items purchased over the last month and are compared to the monthly allotment aspect of the preliminary budget. The items are discretionary items and so are paid for from the card-cash account/allotment which is indicated at the top of the screenshot. In the embodiment shown in FIG. 5A, the monthly limit or allotment for card-cash account is $600. Further, the balance of the card-cash as of the date of the screenshot is $99.

The menu options listed at the top of the screenshot allow a user to view the non-monthly account that corresponds to the non-monthly allotment. Other menu items allow a user to choose different options such as defining categories for certain purchase items or viewing the spending history for the past several months and marking which months were good and which were bad in terms of spending. Other embodiments may also provide additional analytics such as which category was over budget for certain bad months (e.g. dining—user ate out too much when compared to user's spending history). Using the “−”, “+”, and heart push buttons on the screenshot, a user may debit, credit, or perform an account transfer with respect to the account.

Referring to FIG. 5B, the figure is an exemplary screenshot of the debit web page for a spending management software application. The user may enter the amount or cost of a recently purchased item, a payee of the item, whether there is a split for the cost of the item between two or more members of the household such that it is attributed to each member's card-cash allotment. The split may be chosen from listed drop down menu items which are different percentage between two or more people. For example, a user may choose a 50% split between himself and his wife if the entered, recently purchased item was groceries that will be consumed by the household or was a dining expense shared by a user and his wife.

Referring to FIG. 5C, the user enters a $120 amount for a recently purchased item with the payee of a restaurant named the Girl and the Goat. This dining expense was not split and was purchased on Jul. 22, 2011. After entering information regarding the purchase and clicking the “done” pushbutton, a screenshot such as the one shown in FIG. 5D may be shown. The recently purchased item is listed at the top of the list of purchased items for the month. The balance for the account is shown to be negative and a visual indication is shown at the cost of the recently listed purchased item by highlighting the cost in red to indicate to the user that he should stop spending or purchasing items that are allotted to this allocation (discretionary monthly allocation allotment in the card-cash account) for the rest of the month.

In implementing the spending management software application, embodiments of such a spending management software application may include a manual spending tracking software application running on a client computing device on which the screenshots shown in FIG. 5A-5G are displayed. Further, the manual spending tracking software application may send the cost of a recently purchased item entered into the spending management software application to a computer server such that a server spending tracking information processes such data and provides such data to a regulation engine on the computer server. The regulation engine adds the cost of the recently purchased item to the aggregated cost of the spending items in the monthly discretionary expenses allotment and compares the aggregated cost to the current allocation allotment for monthly discretionary expenses and then provides user feedback some which are visual indicators to a client regulation engine running n the client computing device. Further, the client regulation engine displays the user feedback and the visual indicators on the display of the user client computing device.

Such user feedback may be shown when a user clicks on the recently purchased item listed in the screenshot shown in FIG. 5E. The items is shown to put the user at 103% of his monthly discretionary allotment even though he is only 71% through the month. Thus, the user should return the item so that he is not over budget and may then edit or delete the item from the spending management software by clicking one or more pushbuttons.

Referring to FIG. 5F, the user has deleted the item that has put him over budget and has clicked on the next recently purchased item. The spending management software application shown that he is through 71% of the month but has spent 83% of his budget. The server regulation engine may have provided a visual indication by listing such data in yellow to indicate to the user to slow down his rate of spending on these items for a few days. In another embodiment, the visual indicator or user feedback may show the number of days in which the user must refrain from spending on such items to be back on track in terms of the budget for this particular allotment. Further embodiments may allow a user to enter a proposed/potential/possible item to check whether it would put the user over budget and if so how many days it would take for the user to refrain from purchasing items for the particular allotment to be back on track for the allotment.

Referring to FIG. 5G, the user may click on the “Options” menu item to view a listing of spending history. The user may be able to indicate which of the previous months were bad spending months and which were good spending months as well as define categories for spending items and classify such items accordingly. Indicating good and bad spending months as well classifying items enhances the spending history for the user such that the spending management application, specifically a budget engine as described in the present disclosure can process such spending history data to determine a more accurate budget and allocation allotment for the future.

Although the above embodiments are described to be used by individuals and households persons of ordinary skill in the art understand that the embodiments of the present disclosure can have commercial applications especially for small sized firms.

Note that the functional blocks, methods, devices and systems described in the present disclosure may be integrated or divided into different combination of systems, devices, and functional blocks as would be known to those skilled in the art.

In general, it should be understood that the circuits described herein may be implemented in hardware using integrated circuit development technologies, or yet via some other methods, or the combination of hardware and software objects that could be ordered, parameterized, and connected in a software environment to implement different functions described herein. For example, the present application may be implemented using a general purpose or dedicated processor running a software application through volatile or non-volatile memory. Also, the hardware objects could communicate using electrical signals, with states of the signals representing different data.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for managing cash flow, the method comprising:
generating a preliminary budget based on user input of a spending history of the user, the user input provided by a user interface into a computer server, the budget having one or more budget items;
determining one or more allocation allotments for each budget item by consolidating the preliminary budget based on timing of one or more expenses and the mode of payment for each of the expenses;
causing to generate one or more financial accounts and a cash flow mechanism to couple available funds with a planned timing and mode of payment for those expenses.

2. The method of claim 1, wherein the user input of a spending history of the user is based on fixed expenses and a series of questions to identify planned spending for discretionary spending.

3. The method of claim 1, wherein the user input of a spending history of the user is based on a linear history and monthly income.

4. The method of claim 1, the method further comprising:
receiving input of a cost for each spending item associated with the user;
aggregating the cost of each spending item to a corresponding allocation allotment;
comparing aggregated cost of each spending item with the budget allocation allotments;
providing user feedback for each spending item in a chronological relationship between current aggregated costs and allocation allotments in real-time.

5. The method of claim 2, further comprising:
providing user feedback alerting the user whether any spending items causing the user to be over budget;
providing further user feedback describing the amount of time necessary to receiver from any spending item that has caused the user to go over budget.

6. A system for managing cash flow; the system comprising:
a communication network;
a computer server coupled to the communication network, the computer server having a budget engine, a cash flow engine, a spending tracking software application, and a regulation engine;
a database coupled to the computer server;
one or more client computing devices, each client computing device having client spending tracking software application and a client regulation engine.

7. The system of claim 3, further comprising a user interface coupled to the computer server, the user interface providing spending history of a user.

8. The system of claim 6, wherein the computer server stores the spending history of the user in the database, the budget engine accesses the spending history of the user and determines a preliminary budget for the user, the budget having one or more budget items.

9. The system of claim 7, wherein the cash flow engine determines one or more budget categories based on the preliminary budget and determines one or more allocation allotments for each budget item by consolidating the preliminary budget based on timing of one or more expenses and the mode of payment for each of the expenses.

10. The system of claim 8, wherein the cash flow engine causes the generation of one or more bank accounts based on the preliminary budget and one or more allocation allotments and causes the generation of a cash flow mechanism between the one or more accounts to facilitate the flow of funds.

11. The system of claim 6, wherein the spending tracking software application receives a cost of a spending item and stores the spending item and the cost in the database.

12. The system of claim 6, wherein the regulation engine receives the cost of the spending item, adds the cost to determine the aggregate actual costs for that allocation allotment, compares the actual aggregated cost further allocation allotment to current allocation allotment, and provides various indicators to a user interface.

13. A device for managing cash flow; the system comprising:
one or more processors;
one or more storage devices coupled to the one or more processors;
a spending tracking software application and a regulation engine implemented by the one or more processors.

14. The device of claim 13, further comprising a budget engine and a cash flow engine implemented by the one or more processors.

15. The device of claim 13, further comprising a user interface coupled to the computer server, the user interface providing spending history of a user.

16. The device of claim 13, wherein the computer server stores the spending history of the user in the database, the budget engine accesses the spending history of the user and determines a preliminary budget.

17. The device of claim 14, wherein the budget engine determines one or more allocation allotments for each budget item by consolidating the preliminary budget based on timing of one or more expenses and the mode of payment for each of the expenses.

18. The device of claim 15, wherein the cash flow engine causes the generation of one or more bank accounts based on the preliminary budget and one or more allocation allotments and causes the generation of a cash flow mechanism between the one or more accounts to facilitate the flow of funds.

19. The device of claim 13, wherein the spending tracking software application receives a cost of a spending item and stores the spending item and the cost in the database.

20. The device of claim 13, wherein the regulation engine receives the cost of the spending item, adds the cost to determine the aggregate actual costs for that allocation allotment, compares the actual aggregated cost further allocation allotment to current allocation allotment, and provides various indicators to a user interface.
